(19) United States
(12) Patent Application Publication
(10) Pub. No.: US 2022/0135341 A1
(43) Pub. Date: May 5, 2022

(54) POSITION SWITCHING DEVICE

(71) Applicant: DENSO CORPORATION, Kariya-city (JP)

(72) Inventors: Kyohei TAKAHASHI, Kariya-city (JP); Daigo ARAKIDA, Kariya-city (JP)

(21) Appl. No.: 17/575,259

(22) Filed: Jan. 13, 2022

Related U.S. Application Data
(63) Continuation of application No. PCT/JP2020/021760, filed on Jun. 2, 2020.

(30) Foreign Application Priority Data
Jul. 22, 2019 (JP) 2019-134438

(51) Int. Cl. B65G 47/24

(52) U.S. Cl. CPC B65G 47/24

(57) ABSTRACT

A position switching device includes a rotating body, a drive unit, and a plurality of position switching rods. The rotating body has, on a surface, a plurality of position switching groove groups each defining a plurality of switching positions and rotates about one shaft as a rotation axis. The drive unit rotationally drives the rotating body in a first rotation direction or a second rotation direction opposite to the first rotation direction. The plurality of position switching rods each has one end engaged with corresponding one of the plurality of the position switching groove groups and the other end engaged with corresponding one of a plurality of position switching mechanisms.

### CROSS REFERENCE TO RELATED APPLICATIONS

The present application is a continuation application of International Patent Application No. PCT/JP2020/021760 filed on Jun. 2, 2020, which designated the U.S. and claims the benefit of priority from Japanese Patent Application No. 2019-134438 filed on Jul. 22, 2019. The entire disclosures of all of the above applications are incorporated herein by reference.

### TECHNICAL FIELD

The present disclosure relates to a position switching device.

### BACKGROUND

In a shift device that switches a shift position using a rotary shift drum mechanism, the shift position is switched in accordance with rotation, and thus, in general, the shift position can be switched only sequentially.

### SUMMARY

The present disclosure provides a position switching device. The position switching device includes a rotating body, a drive unit, and a plurality of position switching rods. The rotating body has, on a surface, a plurality of position switching groove groups each defining a plurality of switching positions and rotates about one shaft as a rotation axis. The drive unit rotationally drives the rotating body in a first rotation direction or a second rotation direction opposite to the first rotation direction. The plurality of position switching rods each has one end engaged with corresponding one of the plurality of the position switching groove groups and the other end engaged with corresponding one of a plurality of position switching mechanisms.

### BRIEF DESCRIPTION OF DRAWINGS

The features and advantages of the present disclosure will become more apparent from the following detailed description made with reference to the accompanying drawings. In the drawings:

FIG. 1 is an explanatory diagram illustrating a schematic configuration of a position switching device according to a first embodiment;

FIG. 2 is an explanatory diagram schematically illustrating a developed position switching groove group of the position switching device according to the first embodiment;

FIG. 3 is an explanatory diagram schematically illustrating a developed position switching groove group of a conventional position switching device:

FIG. 4 is an explanatory diagram illustrating a switching configuration included in the position switching device according to the first embodiment;

FIG. 5 is an explanatory diagram illustrating an example of a first movement restriction part included in the position switching device according to the first embodiment;

FIG. 6 is an explanatory diagram illustrating an example of a second movement restriction part included in the position switching device according to the first embodiment;

FIG. 7 is an explanatory diagram schematically illustrating a developed position switching groove group of the position switching device according to the first embodiment;

FIG. 8 is an explanatory diagram schematically illustrating a developed position switching groove group of the position switching device according to the first embodiment;

FIG. 9 is an explanatory diagram illustrating a position switching table as an example used in the position switching device according to the first embodiment;

FIG. 10 is an explanatory diagram illustrating a switching pattern of a switching position executable in the position switching device according to the first embodiment;

FIG. 11 is an explanatory diagram schematically illustrating a cam-follower of a position switching rod included in the position switching device according to the first embodiment;

FIG. 12 is an explanatory diagram schematically illustrating an arrangement example of the cam-follower of the position switching rod included in the position switching device according to the first embodiment with respect to the groove;

FIG. 13 is an explanatory diagram schematically illustrating a vehicle equipped with a drive system to which a position switching device according to a second embodiment is applied;

FIG. 14 is an explanatory diagram schematically illustrating a developed position switching groove group of the position switching device according to the second embodiment;

FIG. 15 is an explanatory diagram illustrating a position switching table as an example used in the position switching device according to the second embodiment;

FIG. 16 is an explanatory diagram schematically illustrating a developed position switching groove group according to a third embodiment;

FIG. 17 is an explanatory diagram illustrating a switching pattern of a switching position executable in the position switching device according to the third embodiment;

FIG. 18 is an explanatory diagram schematically illustrating a developed position switching groove group of a position switching device according to a fourth embodiment;

FIG. 19 is an explanatory diagram illustrating an example of a movement restriction part according to a fifth embodiment;

FIG. 20 is an explanatory diagram illustrating an example of a position switching rod according to a sixth embodiment; and

FIG. 21 is a flowchart illustrating an example of a processing flow performed in position switching control performed in the position switching device.

### DETAILED DESCRIPTION

For example, a shift device that enables a shift position to be skipped through a neutral position has been proposed.

However, even in the shift device capable of skipping the shift position, there is a difficulty that the shift position cannot be directly switched from a current shift position to a target shift position or the shift position cannot be switched between arbitrary shift positions.

Accordingly, in a position switching device that performs position switching using a rotating body, it is required to enable position switching directly from a current switching position to an arbitrary target switching position.

The present disclosure provides a position switching device capable of switching directly from a current switching position to an arbitrary target switching position.

An exemplary embodiment of the present disclosure provides a position switching device that includes a rotating body, a switching configuration, a drive unit, and a plurality of position switching rods. The rotating body has, on a surface, a plurality of position switching groove groups each defining a plurality of switching positions and rotates about one shaft as a rotation axis. The switching configuration is provided in at least one position switching groove group of the plurality of position switching groove groups. The switching configuration causes a combination of the plurality of switching positions switched in an order determined according to a rotation to directly switch to a target combination not dependent on the order. The drive unit rotationally drives the rotating body in a first rotation direction or a second rotation direction opposite to the first rotation direction. The plurality of position switching rods each has one end engaged with corresponding one of the plurality of the position switching groove groups and the other end engaged with corresponding one of a plurality of position switching mechanisms.

In the exemplary embodiment of the present disclosure, the position switching device enables position switching directly from a current switching position to an arbitrary target switching position.

Another exemplary embodiment of the present disclosure provides a rotating body that rotates about one shaft as a rotation axis used in a position switching device is provided. The rotating body that rotates about one shaft as a rotation axis used in a position switching device is provided. The rotating body includes a plurality of position switching groove groups and a switching configuration. The plurality of position switching groove groups each defines a plurality of switching positions and formed on a surface. The switching configuration is provided in at least one position switching groove group of the plurality of position switching groove groups. The switching configuration causes a combination of the plurality of switching positions switched in an order determined according to a rotation to directly switch to a target combination not dependent on the order.

In another exemplary embodiment of the present disclosure, the rotating body enables position switching directly from a current switching position to an arbitrary target switching position.

A position switching device according to the present disclosure will be described below on the basis of some embodiments.

### First Embodiment

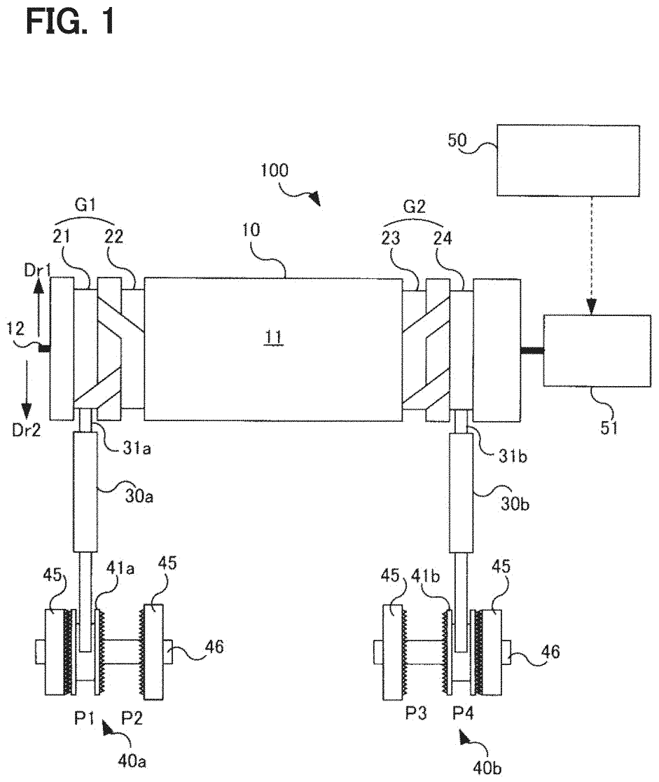

As illustrated in FIG. 1, a position switching device 100 according to a first embodiment includes at least a rotating body 10, an electric motor 51, and position switching rods 30a, 30b. The position switching device 100 may further include position switching mechanisms 40a, 40b. The position switching device 100 achieves desired position switching by being rotationally driven in a first rotation direction Dr1 or a second rotation direction Dr2 opposite to the first rotation direction Dr1 by the electric motor 51 driven and controlled by a control unit 50.

The rotating body 10 has a cylindrical shape or a columnar shape, and rotates in the first rotation direction Dr1 or the second rotation direction Dr2 with one shaft 12 extending in the longitudinal direction as a rotation axis. The rotating body 10 has, on a surface 11, a plurality of position switching groove groups G1, G2 defining a plurality of switching positions P1, P2, P3, P4 enabling direct switching from the current switching position to any target switching position. The position switching groove group G1 includes a plurality of grooves 21, 22, and the position switching groove group G2 includes a plurality of grooves 23, 24. The switching positions P1, P2, P3, P4 are defined by the positions of the grooves 21, 22, 23, 24 in the longitudinal direction of the rotating body 10, that is, in the axial direction. While two position switching groove groups G1, G2, two grooves 21, 22, and two grooves 23, 24 are illustrated as the plurality of position switching groove groups and the plurality of grooves in FIG. 1, there may be three or more of the position switching groove groups and the grooves. The switching position refers to a moving position of the base end which is one end of the position switching rods 30a, 30b switchable by the position switching device 100, and refers to a position achieved by the position switching mechanisms 40a, 40b that are displaced with the position movement of the position switching rods 30a, 30b. The position switching groove groups G1, G2 represented on the surface 11 of the rotating body 10 are schematically illustrated for the sake of description in FIG. 1, and there is no correspondence between the illustration in FIG. 1 and the shape described in detail below.

The drive shaft of the electric motor 51 is connected to the shaft 12 directly or indirectly through a speed reducer. The electric motor 51 is an example of a drive unit, and various actuators capable of applying a rotational force to the shaft 12, such as a hydraulic motor, a pneumatic motor, a magnetic motor, and an ultrasonic motor, can be used as the drive unit. The drive unit is also referred to as a driver.

The position switching rods 30a, 30b are provided according to the number of position switching groove groups G1, G2. Cam-followers 31a, 31b are provided at base ends, that is, end parts that engage with the grooves 21 to 24, of the position switching rods 30a, 30b, and draw a trajectory defined by the grooves 21 to 24 according to the rotation of the rotating body 10. Tip ends which are the other ends, that is, end parts that engage with the position switching mechanisms 40a, 40b, of the position switching rods 30a, 30b have a fork shape.

The position switching mechanisms 40a, 40b include a drive shaft 46, shift sleeves 41a, 41b, and an output gear 45. The drive shaft 46 is connected to a power source (not illustrated) from the outside, and power from the power source, that is, rotational torque is input to the drive shaft 46. The shift sleeves 41a, 41b include a cylindrical engaged part having an outer peripheral part with which the fork-shaped parts at the tip ends of the position switching rods 30a, 30b are rotatably engaged and an inner peripheral part spline-coupled to the drive shaft 46, that is, a hub, and ring-shaped teeth disposed at both axial ends of the engaged part. The shift sleeves 41a, 41b are movable in the axial direction and rotate together with the drive shaft 46 by spline-coupling the engaged part with the drive shaft 46. The output gear 45 is a disk-shaped gear that is not connected to the drive shaft 46 and is not directly driven by the drive shaft 46. When the shift sleeves 41a, 41b move and the teeth of the shift sleeves 41a, 41b are engaged with the teeth of the output gear 45, the driving force input to the drive shaft 46 is transmitted to the output gear 45. In the present embodiment, the position switching mechanisms 40a, 40b are implemented as dog clutch mechanisms that switch transmission destinations of the driving force input to the drive shaft 46. The position switching mechanisms 40a, 40b may be implemented as a synchronization clutch mechanism in which a synchronization mechanism is incorporated. Other than the clutch mechanism that executes connection and disconnection of power transmission, the position switching mechanisms 40a, 40b may be a switching mechanism that switches the operation mode of a target mechanism or target device by achieving locking and unlocking, for example, by moving the tip ends of the position switching rods 30a, 30b.

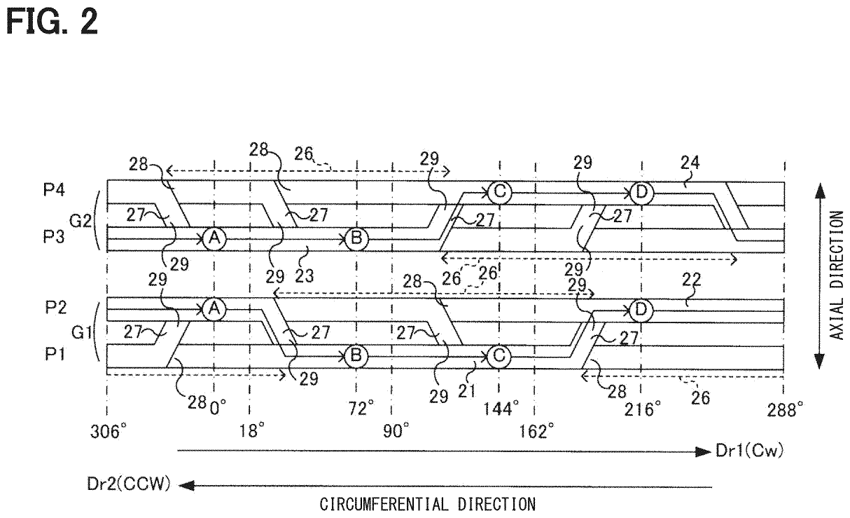

The configurations of the position switching groove groups G1, G2 that enable direct position switching from the current switching position to an arbitrary target switching position will be described in detail with reference to FIGS. 2 to 8. FIGS. 2, 4, 7, and 8 schematically illustrate the position switching groove groups G1, G2 developed in the circumferential direction of the rotating body 10, and the grooves 21 to 24 are formed in a loop shape over the entire circumference of the rotating body 10, that is, the circumferential direction. The shapes of the position switching groove groups G1, G2 in FIGS. 2, 4, 7, and 8 do not correspond to the shapes of the position switching groove groups G1, G2 illustrated on the surface 11 of the rotating body 10 illustrated in FIG. 1.

In the first embodiment, as illustrated in FIG. 2, the position switching groove groups G1, G2 include two grooves defining switching positions, that is, the groove 21 and the groove 22, and the groove 23 and the groove 24, respectively. In a case where the position switching groove groups G1, G2 include the groove 21 and the groove 22, and the groove 23 and the groove 24, respectively, the combination of the switching positions has four patterns A to D. Specifically, there are a combination A in which the switching positions P2 and P3 are defined by the groove 22 and the groove 23, a combination B in which the switching positions P1 and P3 are defined by the groove 21 and the groove 23, a combination C in which the switching positions P1 and P4 are defined by the groove 21 and the groove 24, and a combination D in which the switching positions P2 and P4 are defined by the groove 22 and the groove 24. The sign positions A to D in the grooves are the positions where the cam-followers 31a, 31b of the position switching rods 30a, 30b exist. When the rotating body 10 is rotated in the first rotation direction Dr1, that is, a clockwise direction CW, the combination of the switching positions is sequentially changed in the order of A, B, C, D, and A, and when the rotating body 10 is rotated in the second rotation direction Dr2, that is, a counterclockwise direction CCW, the combination of the switching positions is sequentially changed in the order of D, C, B, A, and D. In order to simplify the following description, as the rotation angles at which the combinations appear according to the rotation of the rotating body 10, combination A: 0°, combination B: 72°, combination C: 144°, and combination D: 216° are assigned for convenience.

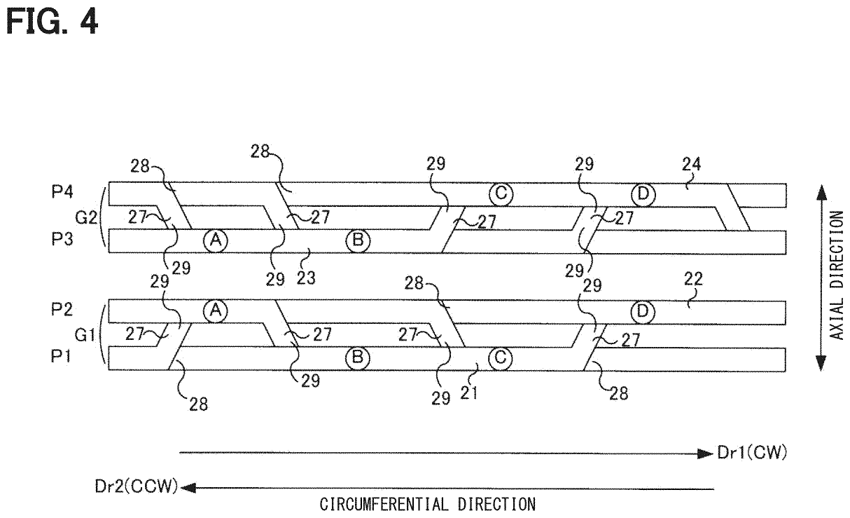

The grooves 21 and 22 and the grooves 23 and 24 are provided with switching configurations 26, 27, 28 for directly switching a combination of two switching positions, which is switched in an order determined according to rotation, to a target combination not dependent on the order. More specifically, the switching configurations 26, 27, 28 are configurations for directly switching to two target switching positions defining a target combination while maintaining two current switching positions defining a current combination. The switching configurations 26, 27, 28 only need to be provided in at least one of the plurality of position switching groove groups G1, G2. The switching configurations 26, 27, 28 will be described in detail with reference to FIG. 4.

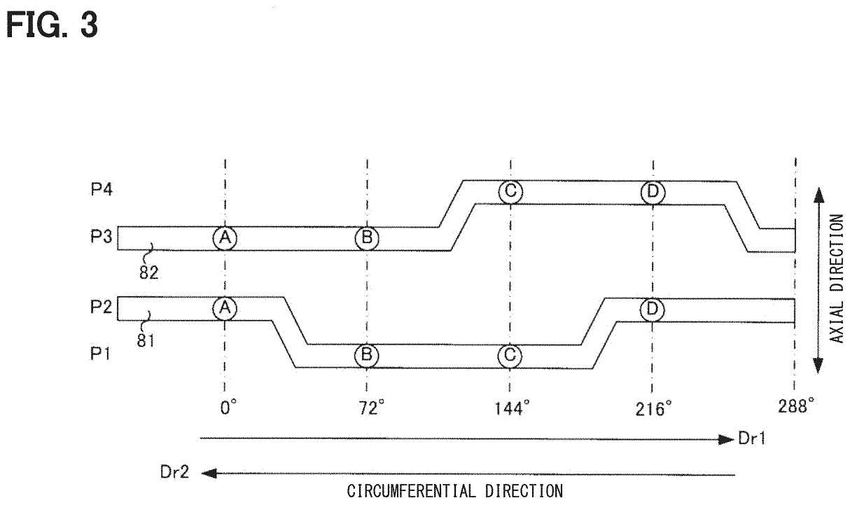

Grooves 81, 82 included in the conventional position switching device illustrated in FIG. 3 have shapes in which one continuous groove defines different switching positions in the axial direction of a rotating body. Accordingly, the combinations A to D of switching positions must always be switched in the order from A to D in the clockwise direction CW, and in the order from D to A in the counterclockwise direction CCW. Accordingly, for example, it is not possible to directly switch from the combination A to the combination C or from the combination C to the combination A by skipping the combination B.

On the other hand, the position switching device 100 according to the first embodiment includes the switching configurations 26, 27, so that the position can be directly switched from the current switching position to an arbitrary target switching position regardless of the order defined according to the rotation of the rotating body 10. The switching configurations 26, 27 are configurations for switching the current switching position to the target switching position without passing through an intermediate switching position different from the current switching position among a plurality of intermediate switching positions defining intermediate combinations that form an order between the current combination and the target combination. Since the switching positions P1 to P4 are defined by the grooves 21 to 24, the switching configuration 27 is implemented by the communication path 27 that connects, among a plurality of current grooves defining the current combination, the current groove different from a plurality of target grooves defining the target combination, with the plurality of target grooves. The switching configuration 26 is implemented by the bypass 26 that is connected to the communication path 27 while bypassing, among a plurality of intermediate grooves defining the intermediate combinations in the order determined according to the rotation of the rotating body 10, a groove different from the plurality of current grooves defining the current combination, and forms a part of the plurality of current switching grooves. That is, the bypass 26 is a bypass groove for maintaining the current groove up to the communication path 27 that connects the current groove and the target groove without passing through an intermediate groove different from the current groove. Depending on the pattern of the groove 21 to 24, the bypass 26 may be newly formed to be a part of the current groove, or a part of an existing current groove may function as the bypass 26.

Depending on the pattern of the grooves 21 to 24, the communication path 27 can take any mode of connecting a current groove having the bypass 26 among the plurality of current grooves and a target groove different from the current groove having the bypass 26 among the plurality of target grooves, or connecting a current groove not having the bypass 26 and a target groove different from the current groove not having the bypass 26 among the plurality of target grooves. In either mode, in the first rotation direction, the communication path 27 branches at an obtuse angle with respect to the current groove, and intersects with the current groove and the target groove so as to merge at an acute angle with respect to the target groove. In the pattern of the grooves 21 to 24 illustrated in FIGS. 2, 4, 7, and 8, since the grooves 22, 23 defining the current combination A and the grooves 21, 24 defining the target combination C sandwiching the intermediate combination B are two different grooves, the communication path 27 is a communication path that connects the current groove having the bypass 26 among the plurality of current grooves and the target groove different from the current groove having the bypass 26 among the plurality of target grooves.

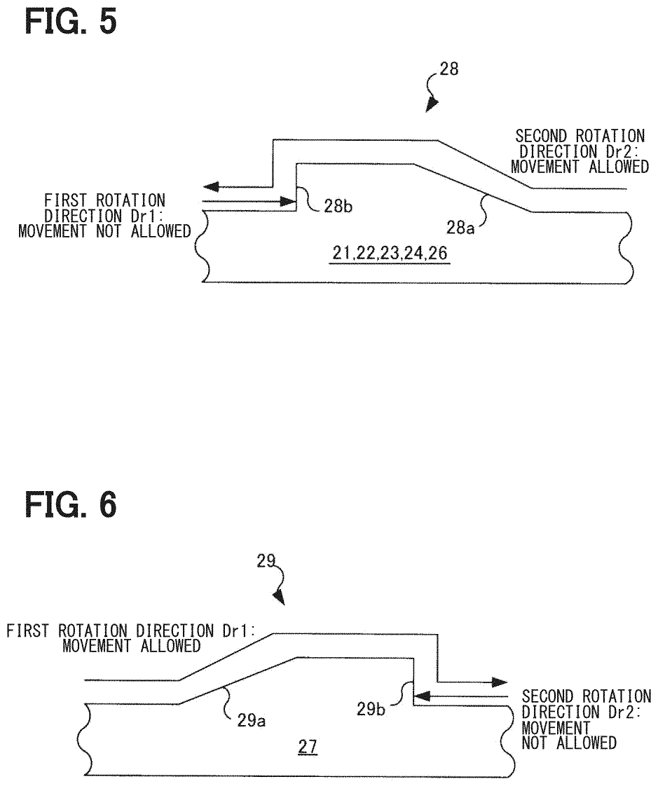

As illustrated in FIG. 4, a first movement restriction part 28 is disposed corresponding to a position where the communication path 27 and the bypass 26 are connected, that is, the intersecting position with the communication path 27 in at least one of the current grooves, the grooves 21, 22, 23, 24. The first movement restriction part 28 does not allow movement of the position switching rods 30a, 30b in the current groove and allows movement from the current groove to the communication path 27 in the first rotation direction Dr1, and allows movement of the position switching rods 30a, 30b in the current groove in the second rotation direction Dr2. As illustrated in FIG. 5, a stepped part 28b, for example, is provided to not allow movement of the position switching rods 30a, 30b in the current groove and allow movement of the position switching rods 30a, 30b to the communication path 27 in the first rotation direction Dr1, and an inclined part 28a, for example, is provided to allow movement of the position switching rods 30a, 30b in the current groove in the second rotation direction Dr2. In the present embodiment, the communication path 27 is disposed or formed so as to move the position switching rods 30a, 30b from the current groove to the target groove when the rotating body 10 is rotated in the first rotation direction Dr1. In the examples of FIGS. 2, 4, 7, and 8, the first movement restriction part 28 is disposed at an end position of the bypass 26 connected to the communication path 27. As a result, since the movement of the position switching rods 30a, 30b in the second rotation direction Dr2 is allowed, the position switching rods 30a, 30b are allowed to reach the communication path 27 while maintaining the current groove through the bypass 26. Then, since the movement of the position switching rods 30a, 30b in the current groove in the first rotation direction Dr1 is not allowed, the position switching rods 30a, 30b are moved from the current groove to the target groove through the communication path 27.

As illustrated in FIG. 4, the communication path 27 includes a second movement restriction part 29 that allows movement of the position switching rods 30a, 30b from one to the other between adjacent grooves of the plurality of grooves in the first rotation direction Dr1, and does not allow movement of the position switching rods 30a, 30b between adjacent grooves in the second rotation direction Dr2. As illustrated in FIG. 6, an inclined part 29a, for example, is provided to allows movement of the position switching rods 30a, 30b from one to the other between adjacent grooves in the first rotation direction Dr1, and a stepped part 29b, for example, is provided to not allow movement of the position switching rods 30a, 30b between adjacent grooves in the second rotation direction Dr2. Since the second movement restriction part 29 is provided, when the rotating body 10 is rotated in the second rotation direction Dr2 and the position switching rods 30a, 30b move in the current groove, movement to the adjacent groove through the communication path 27 is prevented. When the rotating body 10 is rotated in the first rotation direction Di, the second movement restriction part 29 allows the position switching rods 30a, 30b moving in the current groove to move to the adjacent groove, that is, the target groove through the communication path 27. The second movement restriction part 29 does not necessarily have to be provided depending on the angle at which the communication path 27 intersects with the groove 21 to 24, and even in such a case, undesirable movement of the position switching rods 30a, 30b is prevented by providing the second movement restriction part 29.

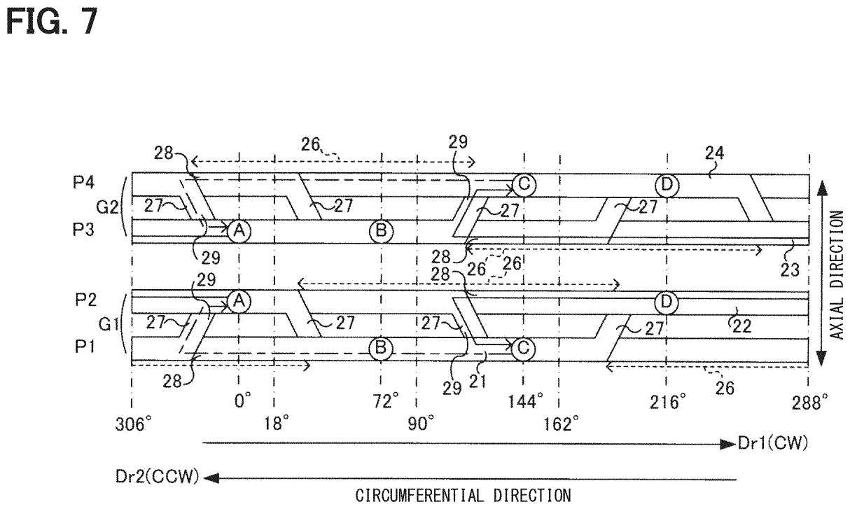

An example of switching of the switching position performed between the combination A and the combination C will be described with reference to FIG. 7. In the switching from the combination A to the combination C indicated by the solid line, the rotating body 10 is rotated to a rotation angle of 90° beyond the bypass 26 in the counterclockwise direction CCW, so that the switching position P3 (groove 23) defining the combination A, which is different from the switching position P4 (groove 24) defining the combination D, is maintained. By rotating the rotating body 10 to a rotation angle of 144° in the clockwise direction CW, the switching positions P2 and P3 are switched to the switching positions P1 and P4, respectively, by the communication path 27 connecting the groove 23 and the groove 24 and the communication path 27 connecting the groove 22 and the groove 21. The direct switching from the combination C to the combination A indicated by the alternate long and short dash line is similarly performed. More specifically, the cam-followers 31a, 31b of the position switching rods 30a, 30b move from the switching position P2 to P1 and from P3 to P4, so that the switching from the current switching position to the target switching position is achieved.

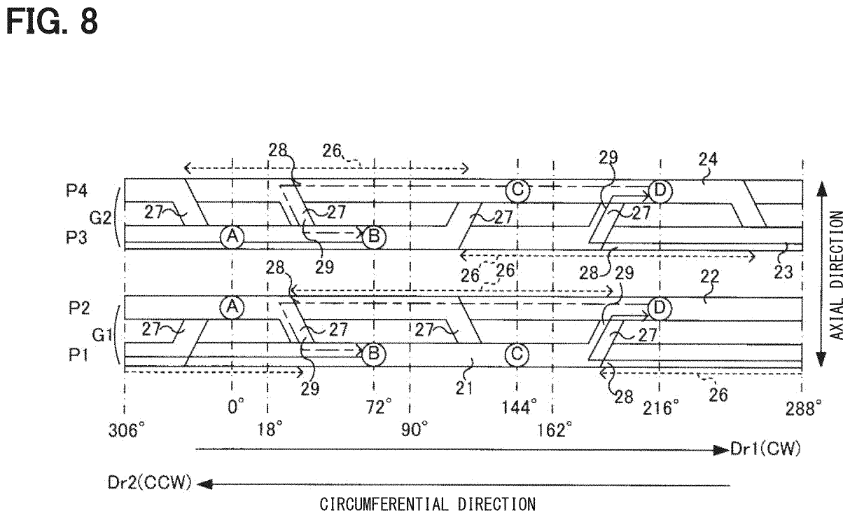

An example of switching of the switching position performed between the combination B and the combination D will be described with reference to FIG. 8. In the switching from the combination B to the combination D indicated by the solid line, the rotating body 10 is rotated to a rotation angle of 162° beyond the bypass 26 in the counterclockwise direction CCW, so that the switching position P1 (groove 21) defining the combination B, which is different from the switching position P2 (groove 22) defining the combination A, is maintained. By rotating the rotating body 10 to a rotation angle of 216° in the clockwise direction CW, the switching positions P1 and P3 are switched to the switching positions P2 and P4, respectively, by the communication path 27 connecting the groove 23 and the groove 24 and the communication path 27 connecting the groove 22 and the groove 21. The direct switching from the combination D to the combination B indicated by the alternate long and short dash line is similarly executed. More specifically, the cam-followers 31a, 31b of the position switching rods 30a, 30b move from the switching position P1 to P2 and from P3 to P4, so that the switching from the current switching position to the target switching position is achieved.

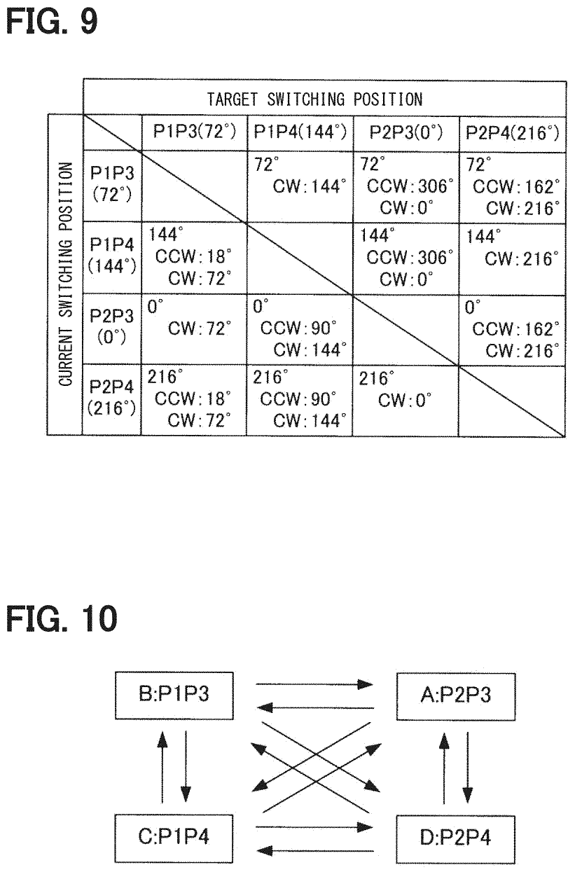

While the switching of some of the combinations A to D has been described in FIGS. 7 and 8, the switching among all the combinations illustrated in FIG. 10, that is, the direct switching from the current switching position to an arbitrary target switching position is achieved by controlling the rotation direction and the rotation angle of the rotating body 10 by the electric motor 51 according to a table associating the current switching position and the target switching position illustrated in FIG. 9.

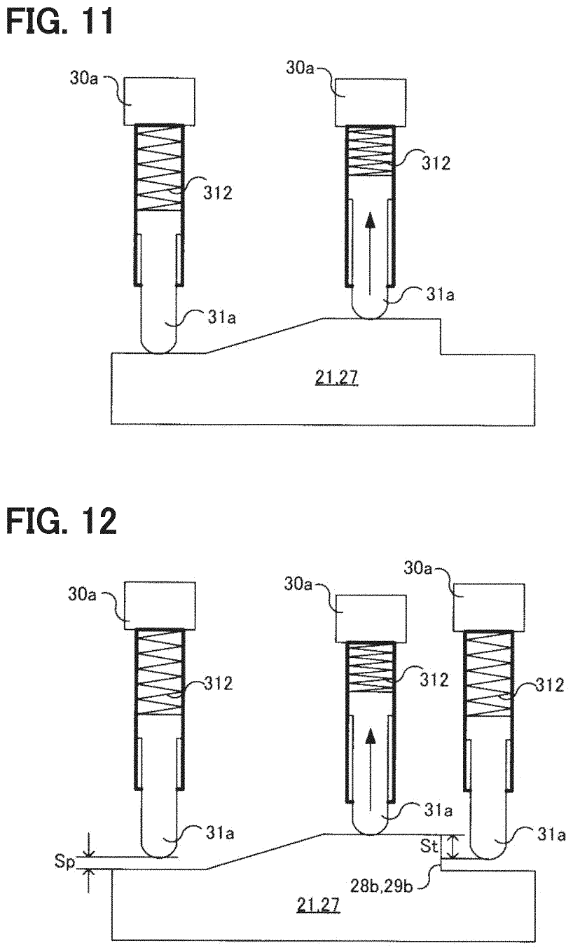

The base ends of the position switching rods 30a, 30b will be described with reference to FIG. 11. While the position switching rod 30a will be described as an example in FIG. 11, the position switching rod 30b has a similar configuration. The cam-follower 31a is allowed to move in the axial direction and is biased toward the groove 21 to 24 and the communication path 27 by a biasing mechanism 312, such as a metal/resin spring or a hydraulic/pneumatic piston. As a result, the tip end of the cam-follower 31a slides on the bottom or bottom surface of the groove 21 to 24 or the communication path 27 to more accurately trace the switching position defined by the groove 21 to 24.

As illustrated in FIG. 12, the position switching rod 30a may be disposed such that the tip end of the cam-follower 31a is located at a position separated from the bottom or bottom surface of the groove 21 to 24 or the communication path 27 by a spacing Sp. By separating the tip end of the cam-follower 31a from the bottom or bottom surface of the groove 21 to 24 or the communication path 27, sliding resistance can be eliminated, responsiveness of the position switching device 100 can be improved, and wear of the rotating body 10, that is, the bottom or bottom surface of the groove 21 to 24 or the communication path 27 can be prevented. The spacing Sp is set sufficiently smaller than a step height St of the stepped part 29b in order to maintain the functions of the first and second movement restriction parts 28, 29.

According to the position switching device 100 of the first embodiment described above, at least one position switching groove group of the plurality of position switching groove groups G1, G2 includes the switching configurations 26, 27, 28 for directly switching a combination of the plurality of switching positions P1 to P4 switched in an order determined according to rotation, to a target combination not dependent on the order. Hence, the position switching device 100 that performs position switching using the rotating body 10 can directly switch position from the current switching position to an arbitrary target switching position. That is, by using one rotating body 10, the control unit 50 rotationally drives the rotating body 10 in the first rotation direction Dr1 to switch the combination of the switching positions in order, and rotationally drives the rotating body 10 in the second rotation direction Dr2 and then rotationally drives the rotating body 10 in the first rotation direction Dr1 to achieve a combination of the switching positions not dependent on the order. Thus, the position can be switched directly from the current switching position to an arbitrary target switching position.

More specifically, the position switching device 100 according to the first embodiment includes: as the switching configurations 26, 27, 28, the communication path 27 that connects a current groove different from a plurality of target grooves among a plurality of current grooves and the target groove; the bypass 26 that bypasses an intermediate groove different from the plurality of current grooves among a plurality of intermediate grooves that define an intermediate combination that is a combination between the current combination and the target combination in the order and forms a part of the plurality of current grooves or is included in the plurality of current grooves; and a first movement restriction part 28 disposed in the current groove corresponding to a position where the communication path 27 is connected, the first movement restriction part 28 not allowing movement of the position switching rods 30a, 30b in the current groove and allowing movement of the position switching rods 30a, 30b from the current groove to the communication path 27 in the first rotation direction Dr1, and allowing movement of the position switching rods 30a, 30b in the current groove in the second rotation direction Dr2. Accordingly, by rotating the rotating body 10 in the second rotation direction Dr2, the position switching rods 30a, 30b can bypass the intermediate groove and move in the current groove until the position switching rods 30a, 30b exceed the communication path 27 connecting with the target groove. By rotating the rotating body 10 in the first rotation direction Dr1 after the position switching rods 30a, 30b exceed the communication path 27, the position switching rods 30a, 30b can move to the target groove through the communication path 27. As a result, among the plurality of intermediate grooves, the plurality of current grooves can be directly switched to the plurality of target grooves without passing through an intermediate groove different from the plurality of current grooves.

### Second Embodiment

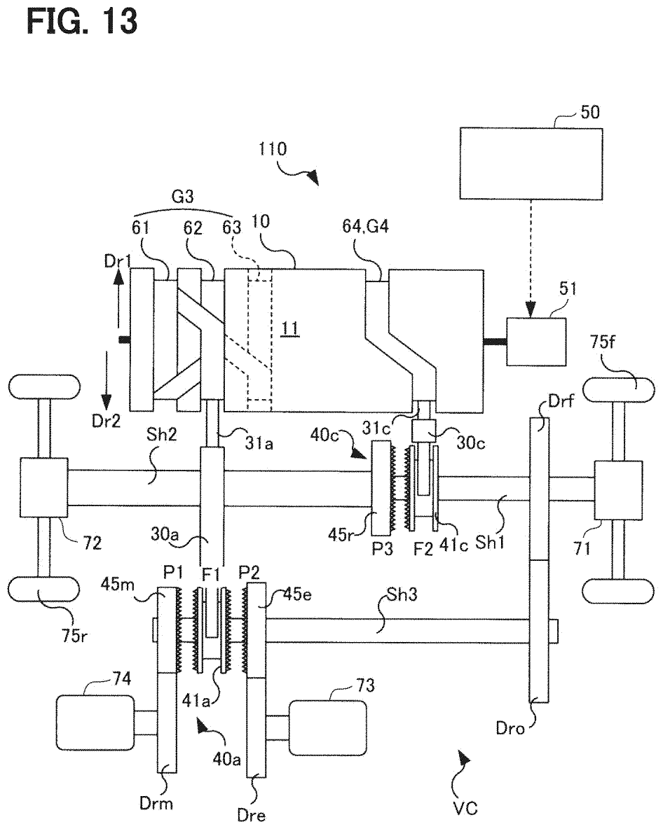

A vehicle equipped with a drive system to which a position switching device according to a second embodiment is applied will be described. A position switching device 110 according to the second embodiment has a configuration similar to the position switching device 100 according to the first embodiment except that the shapes of the position switching groove group and the groove provided on the surface of the rotating body are different. Hence the same reference numerals as those used in the first embodiment are assigned to common configurations, and the description thereof will be omitted. First and second position switching groove groups G3, G4 represented on a surface 11 of a rotating body 10 are schematically illustrated for the sake of description in FIG. 13, and there is no correspondence between the illustration in FIG. 13 and the shape described in detail below.

As illustrated in FIG. 13, a position switching device 110 according to the second embodiment includes an internal combustion engine 73 and a motor 74 as power sources, and is used by being mounted on a vehicle VC capable of switching between two-wheel drive and four-wheel drive. The drive system of the vehicle VC includes a front wheel 75f, a rear wheel 75r, a front differential gear 71, and a rear differential gear 72. The front wheel 75f is mechanically connected to a front drive shaft Sh1 through the front differential gear 71. A front driven gear Drf is connected to the middle of the front drive shaft Sh1, and a shift sleeve 41c is connected to the tip end of the front drive shaft Sh1. The rear wheel 75r is mechanically connected to a rear drive shaft Sh2 through the rear differential gear 72. An output gear 45r is connected to the tip end of the rear drive shaft Sh2. The shift sleeve 41c, a position switching rod 30c, a cam-follower 31c, and the output gear 45r form at least a part of a position switching mechanism 40c as a second dog set. When the position switching rod 30c is switched to a third switching position P3, the shift sleeve 41c and the output gear 45r mesh with each other, the front drive shaft Sh1 and the rear drive shaft Sh2 are connected, and the two-wheel drive is switched to the four-wheel drive. When the position switching rod 30c is switched to a second neutral position F2, the shift sleeve 41c does not mesh with the output gear 45r, the driving force from the front drive shaft Sh1 is not transmitted to the rear drive shaft Sh2, and the two-wheel drive state is established.

The power system of the vehicle VC includes the internal combustion engine 73, the motor 74, and a power source shaft Sh3. A power output gear Dro is connected to one end of the power source shaft Sh3, and a position switching mechanism 40a as a first dog set, more specifically, a shift sleeve 41a is connected to the other end of the power source shaft Sh3. The power output gear Dro meshes with the front driven gear Drf. The internal combustion engine 73 includes an internal combustion engine driving gear Dre on an output shaft. The internal combustion engine driving gear Dre meshes with an output gear 45e. The motor 74 includes a motor driving gear Drm on an output shaft. The motor driving gear Drm meshes with an output gear 45m. When a position switching rod 30a is switched to a first switching position P1, the shift sleeve 41a and the output gear 45m mesh with each other, and the driving force output from the motor 74 is transmitted to the power source shaft Sh3. When the position switching rod 30a is switched to a second switching position P2, the shift sleeve 41a and the output gear 45e mesh with each other, and the driving force output from the internal combustion engine 73 is transmitted to the power source shaft Sh3. When the position switching rod 30a is switched to a first neutral position F1, the shift sleeve 41a does not mesh with the output gears 45e, 45m, the driving force from the internal combustion engine 73 and the motor 74 is not transmitted to the power source shaft Sh3, and a neutral state is obtained.

The rotating body 10 includes a first position switching groove group G3 and a second position switching groove group G4. The first position switching groove group G3 includes a first groove 61 defining the first switching position P1, a second groove 62 defining the neutral position F1, and a third groove 63 defining the second switching position P2 in the axial direction of the rotating body 10. The second position switching groove group G4 includes a fourth groove 64 having a groove position defining the third switching position P3 and a groove position defining the second neutral position F2 in the axial direction of the rotating body 10. The term position switching groove group means a group of two or more independent grooves, and may also be used to include one groove that has a plurality of groove positions with switching positions and in which a plurality of grooves do not overlap in the axial direction. That is, the position switching groove group may be a group of grooves that can define a plurality of switching positions.

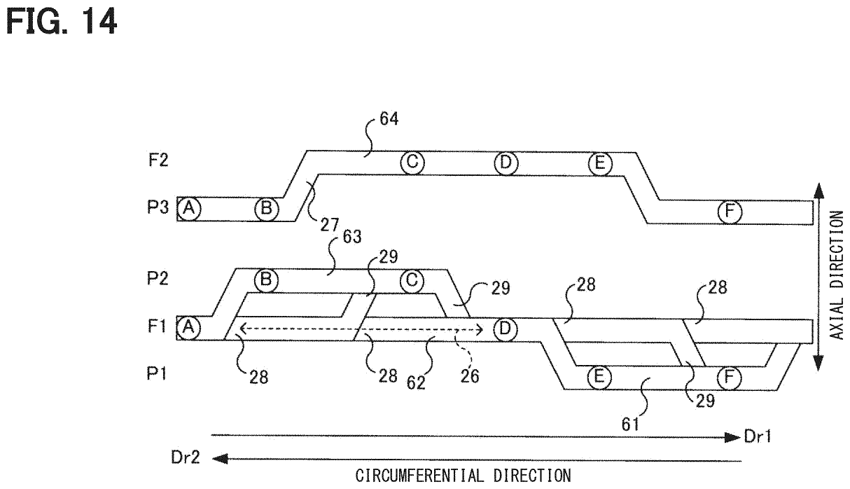

The rotating body 10 included in the position switching device 110 according to the second embodiment has a pattern of position switching groove groups illustrated in FIG. 14. Similarly to the first embodiment, the first position switching groove group G3 includes a bypass 26, a communication path 27, and a first movement restriction part 28 as a switching configuration. In addition, the first position switching groove group G3 includes a second movement restriction part 29. In the position switching device 110 according to the second embodiment, the first position switching groove group G3 includes three grooves 61, 62, and 63 to define three switching positions. The second position switching groove group G4 includes one groove 64 defining two switching positions. The grooves 62 and 64 are continuously formed in the circumferential direction of the rotating body 10. The combinations of the switching positions in the example of FIG. 14 are six patterns A to F. Specifically, there are a combination A in which the switching positions F1 and P3 are defined by the groove 62 and the groove 64, a combination B in which the switching positions P2 and P3 are defined by the groove 63 and the groove 64, a combination C in which the switching positions P2 and F2 are defined by the groove 63 and the groove 64, a combination D in which the switching positions F1 and F2 are defined by the groove 62 and the groove 64, a combination E in which the switching positions P1 and F2 are defined by the groove 61 and the groove 64, and a combination F in which the switching positions P1 and P3 are defined by the groove 61 and the groove 64. The sign positions A to F in the grooves are the positions where cam-followers 31a, 31c of the position switching rods 30a, 30c exist. When the rotating body 10 is rotated in a first rotation direction Dr1, that is, a clockwise direction CW, the combination of the switching positions is sequentially changed in the order of A, B, C, D, E, F, and A, and when the rotating body 10 is rotated in a second rotation direction Dr2, that is, a counterclockwise direction CCW, the combination of the switching positions is sequentially changed in the order of F, E, D, C, B, A, and F.

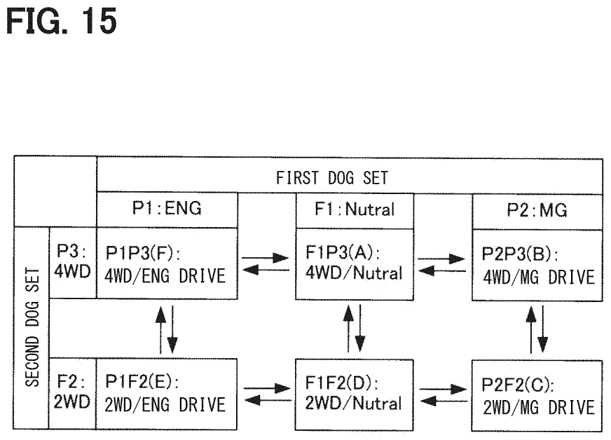

The switching pattern of the drive system achieved by the vehicle VC illustrated in FIG. 13 and the groove pattern illustrated in FIG. 14 is as illustrated in FIG. 15. The two-wheel drive (2WD) and the four-wheel drive (4WD) are switched by the second dog set 40c, and are switched to 4WD in the case of the switching position P3 and to 2WD in the case of the switching position F2. The switching of power sources of the internal combustion engine (ENG) 73, the motor (MG) 74, and neutral is performed by the first dog set 40a, and the power source is switched to the ENG in the case of the switching position P1, to neutral in the case of the switching position F1, and to the MG in the case of the switching position P2. Neutral means a state in which the output gears 45e, 45m are not connected to any power source and idle.

According to the position switching device 110 of the second embodiment described above, for example, in the drive system mounted on the vehicle VC, in the switching pattern including the switching of the drive system and the switching of the power source, it is possible to directly switch to an arbitrary switching pattern. Accordingly, it is possible to perform direct switching for a switching pattern that has conventionally been forced to be switched according to the order and for which direct switching has not been possible. Hence, it is possible to enhance the arbitrariness of the switching pattern that can be executed by the position switching device 110. As a result, the position switching mechanisms 40a, 40c can be switched to desired switching positions at desired timings.

Specifically, in the groove pattern illustrated in FIG. 14, when the combination A is switched to the combination D, since the bypass 26 and the first movement restriction part 28 are provided, the position switching rod 30a can maintain the current groove F1 while the position switching rod 30c can move to the communication path 27 for moving from the switching position F2 to P3, and the combination can be directly changed between the combinations A and D. The switching between the combination A and the combination D is switching between 4WD and 2WD in the neutral state without power transmission from the power source. For example, it is possible to achieve a 2WD traveling state by the internal combustion engine 73 from a 4WD traveling state by the motor 74 without passing through a 4WD traveling state by the internal combustion engine 73. The driving system can be switched in a state where the power source is not connected.

According to the position switching device 110 of the second embodiment, the power source can be arbitrarily switched between the internal combustion engine 73 and the motor 74, and switching between 2WD and 4WD can be achieved in any driving state by the internal combustion engine 73 or the motor 74. Conventionally, in a vehicle including the internal combustion engine 73 and the motor 74 as power sources, 4WD is generally achieved by driving non-driving wheels not driven by the internal combustion engine 73 by the motor 74. However, according to the position switching device 110 of the second embodiment, it is possible to switch between 2WD travel and 4WD travel by the internal combustion engine 73 or the motor 74. While the combination of the switching of the power source and the switching of the driving system has been described as an example above, the position switching device 110 according to the second embodiment may be applied to switching of the gear position of a motor in a vehicle that uses the motor as the power source. The position switching device 110 according to the second embodiment may include the position switching mechanism 40c that achieves a switching position P4 in addition to P3. A combination of switching positions for locking the front drive shaft Sh1 may be added to achieve a parking range for locking the front drive shaft Sh1 from a combination of 2WD+neutral. Moreover, the position switching device 110 according to the second embodiment may be used as a position switching device for switching a gear position in a transmission in the internal combustion engine 73, that is, as a shift actuator.

### Third Embodiment

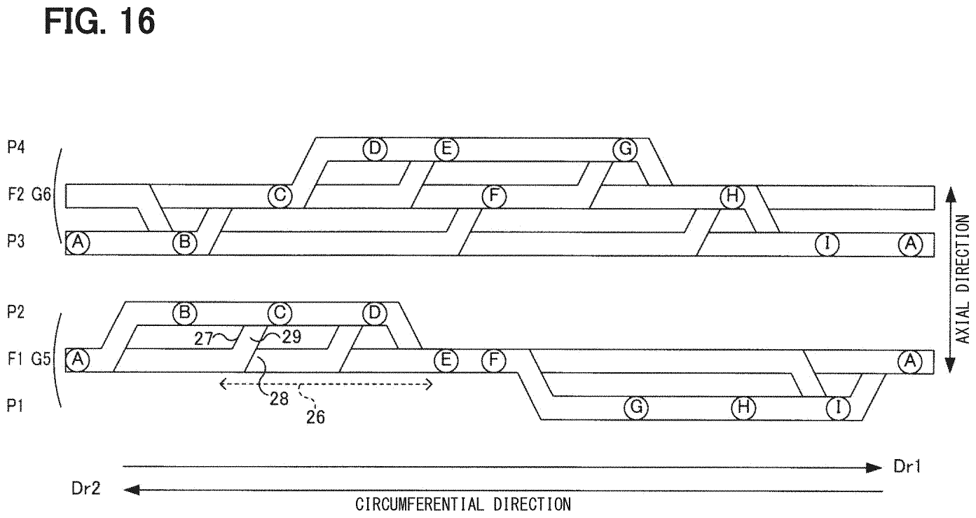

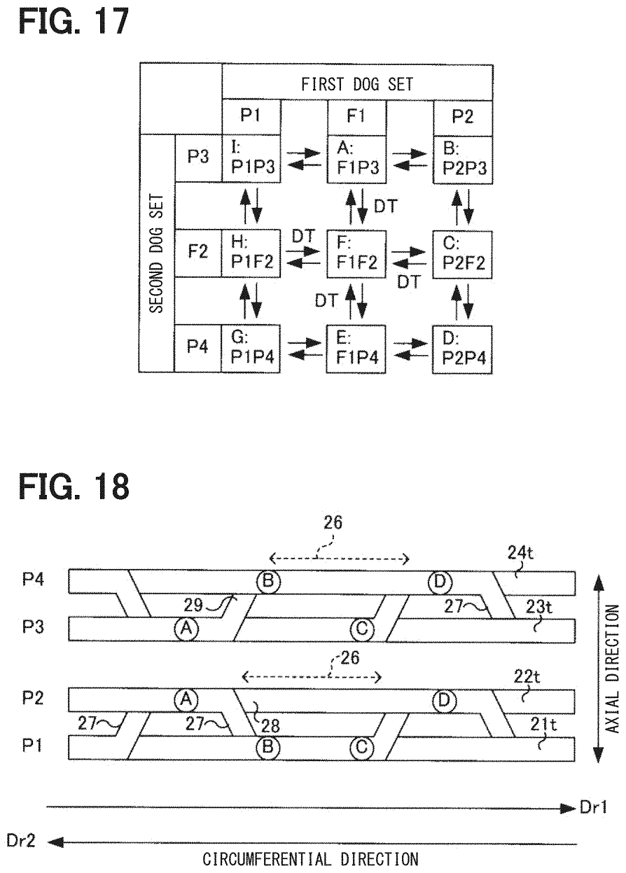

A position switching device according to a third embodiment will be described with reference to FIGS. 16 and 17. The position switching device according to the third embodiment has a configuration similar to the position switching device 100 according to the first embodiment except that the patterns of position switching groove groups G5, G6 provided on the surface of the rotating body are different, and the description thereof is omitted by using the same reference numerals as necessary.

The position switching device according to the third embodiment includes the position switching groove groups G5, G6 illustrated in FIG. 16. The position switching groove groups G5, G6 in the third embodiment both have three grooves defining three switching positions in the axial direction. The groove defining the switching position does not necessarily have to be formed over the circumferential direction of the rotating body as long as three different switching positions can be defined in the axial direction. The position switching groove groups G5, G6 in the third embodiment include a bypass 26, a communication path 27, and a first movement restriction part 28 as a switching configuration. In addition, the position switching groove groups G5, G6 include a second movement restriction part 29. The combinations of the switching positions in the example of FIG. 16 are 10 patterns of A to I. Specifically, there area combination A in which switching positions F1 and P3 are defined, a combination B in which switching positions P2 and P3 are defined, a combination C in which switching positions P2 and F2 are defined, a combination D in which switching positions P2 and P4 are defined, a combination E in which switching positions F1 and P4 are defined, a combination F in which switching positions F1 and F2 are defined, a combination G in which switching positions P1 and P4 are defined, a combination H in which switching positions P1 and F2 are defined, and a combination I in which switching positions P1 and P3 are defined. The sign positions A to I in the grooves are the positions where cam-followers 31a, 31c of position switching rods 30a, 30c exist. When a rotating body 10 is rotated in a first rotation direction Dr1, that is, a clockwise direction CW, the combination of the switching positions is sequentially changed in the order of A, B, C, D, E, F, G, H, I, and A, and when the rotating body 10 is rotated in a second rotation direction Dr2, that is, a counterclockwise direction CCW and then rotated in the first rotation direction Dr1, the combination of the switching positions is sequentially changed in the order of I, H, G, F, E, D, C, B, A, and I. That is, in the third embodiment, the order of combinations is A to I or I to A. The order of appearance from A to I is achieved by the rotation of the rotating body 10 in the first rotation direction Dr1, whereas the order of appearance from I to A is achieved by a combination of the rotation of the rotating body 10 in the second rotation direction Dr2 and in the first rotation direction Dr1. However, even in the latter case, basically, the switching position is sequentially switched from I to A in a predetermined order. Meanwhile, since at least the bypass 26, the communication path 27, and the first movement restriction part 28 are provided as the switching configuration, direct switching between the combinations A and F, between the combinations C and F, between the combinations E and F, and between the combinations H and F to which DT is applied in FIG. 17 is achieved. In FIG. 17, the first dog set corresponds to a position switching mechanism 40a, and the second dog set corresponds to a position switching mechanism 40b. Since the switching position of each dog set is switched by the position switching rods 30a, 30b, the switching position of each dog set can also be referred to as a groove position where the position switching rods 30a, 30b exist. For example, in the switching between the combinations C and F, since the bypass 26 and the first movement restriction part 28 are provided, when the rotating body 10 rotates in the second rotation direction Dr2, the position switching rod 30a can move to the communication path 27 while maintaining the switching position F1, and when the rotating body 10 rotates in the first rotation direction Dr1, the position switching rod 30a can be guided to the communication path 27 by the first movement restriction part 28 and moved to the switching position P2 through the second movement restriction part 29.

According to the position switching device 100 of the third embodiment, when the position switching groove groups G5, G6 include three or more grooves, it is possible to directly switch from the current combination to the target combination without passing through the intermediate combination.

### Fourth Embodiment

A position switching device according to a fourth embodiment will be described with reference to FIG. 18. The position switching device according to the fourth embodiment has a configuration similar to the position switching device 100 according to the first embodiment except that the patterns of position switching groove groups G1, G2 including grooves 21t, 22t, 23t, 24t provided on the surface of the rotating body are different, and the description thereof is omitted by using the same reference numerals as necessary.

In the fourth embodiment, the sequential switching from a combination A to a combination D is achieved by rotating a rotating body 10 in a first rotation direction Dr1. On the other hand, the sequential switching from the combination D to the combination A is achieved by appropriately rotating the rotating body 10 in a second rotation direction Dr2 and the first rotation direction Dr1. For example, the position switching from a combination C to a combination B is achieved by first rotating the rotating body 10 in the second rotation direction Dr2 until exceeding the rotation angle corresponding to the combination D, then rotating the rotating body 10 in the first rotation direction Dr1, and further rotating the rotating body 10 in the second rotation direction Dr2 until reaching the rotation angle corresponding to the combination C. That is, a position switching rod 30a continues to move in the groove 21t, and a position switching rod 30b moves in the groove 24t and then moves to the groove 23t through the communication path 27. On the other hand, the direct switching from the combination D to the combination B sandwiching the intermediate combination C is achieved by first rotating the rotating body 10 in the second rotation direction Dr2 until exceeding the rotation angle corresponding to the combination B, and then rotating the rotating body 10 in the first rotation direction Dr1. That is, the position switching rod 30a does not move to the groove 21t but moves to a position beyond the communication path 27 after passing the first movement restriction part 28 through the groove 22t functioning as the bypass 26. The position switching rod 30a is guided to the communication path 27 by the first movement restriction part 28, passes through the second movement restriction part 29, and reaches the groove 21t. The position switching rod 30b does not move to the groove 23t, passes through the second movement restriction part 29 through the groove 24t functioning as the bypass 26, and moves to a position where the position switching rod 30a exceeds the communication path 27. The position switching rod 30b moving in the groove 24 is not allowed to move to the communication path by the second movement restriction part 29, and thus, remains in the groove 24t. This direct switching is achieved by providing the bypass 26, the communication path 27, and the first movement restriction part 28 which are the switching configuration. The accuracy of direct switching is improved by providing the second movement restriction part 29. As described above, even when the position switching groove groups G1, G2 have a groove pattern in which sequential combination switching is performed, which is not achieved by simple rotation of the rotating body 10 in the first rotation direction Dr1 or the second rotation direction Dr2, direct switching from the current switching position to the target switching position can be achieved by bypassing the intermediate switching position.

### Fifth Embodiment

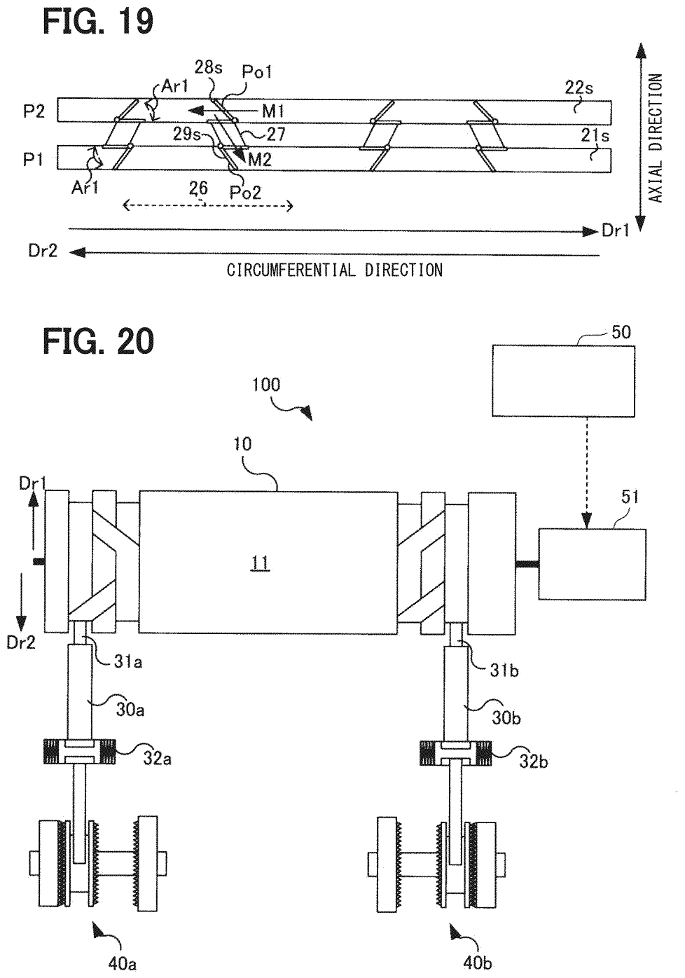

As a fifth embodiment, other modes of the first and second movement restriction parts will be described. In the first to fourth embodiments, static structural features formed in the groove are used as the first movement restriction part 28 and the second movement restriction part 29. On the other hand, in the fifth embodiment, a dynamic configuration disposed in a groove is used. As illustrated in FIG. 19, a first movement restriction part 28s and a second movement restriction part 29s of the fifth embodiment are first and second switching gates 28s, 29s that are disposed in grooves 21s, 22s and switch the communicating state between the groove and a communication path 27. The first and second switching gates 28s, 29s are bidirectionally movable as indicated by arrow AR, and are configured to take Po1 and Po2 as home positions by biasing means, respectively. Accordingly, when a rotating body 10 rotates in a second rotation direction Dr2, a position switching rod 30a located in the groove 22s can pass through the first movement restriction part 28s and move in a bypass 26 in an M1 direction, but cannot move in a reverse M1 direction. When the rotating body 10 rotates in a first rotation direction Dr1, the rotating body 10 is guided to a communication path 27 by the first movement restriction part 28s. When the rotating body 10 rotates in the second rotation direction Dr2, the position switching rod 30a located in the groove 21s cannot enter the communication path 27 from the groove 21s in the direction opposite to the M2 direction due to the second movement restriction part 29s, and maintains the movement in the groove 21s. As the dynamic first movement restriction part 28s and the dynamic second movement restriction part 29s, a ratchet type stopper disposed on the bottom or bottom surface of the grooves 21s, 22s may be used.

### Sixth Embodiment

As a sixth embodiment, another example of the position switching rods 30a, 30b will be described. As illustrated in FIG. 20, position switching rods 30a, 30b may include impact absorption parts 32a, 32b between the position switching rods 30a, 30b and fork-shaped tip ends. The impact absorption parts 32a, 32b include springs as elastic members, and absorb impact when shift sleeves 41a, 41b mesh with an output gear 45 in position switching mechanisms 40a, 40b, that is, stress and vibration generated in the axial direction of the position switching mechanisms 40a, 40b. Since the position switching rods 30a, 30b include the impact absorption parts 32a, 32b, a position switching device 100 can reduce the impact at the time of position switching and can reduce the impact applied to a rotating body 10. Rubber or resin, for example, may be used as the elastic member.

### Seventh Embodiment

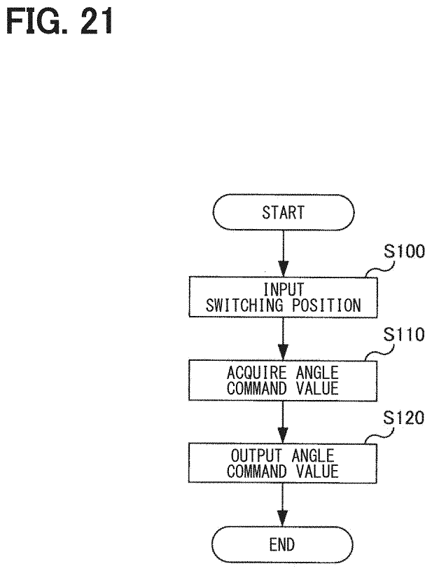

Position switching control performed by the position switching device 100 in each of the above embodiments will be described with reference to FIG. 21. The processing flow illustrated in FIG. 21 is performed by the control unit 50. The control unit 50 includes at least a CPU, a memory, and an input/output interface. The control unit 50 receives the input of the switching position (S100). The reception of the switching position includes, for example, reception of input of a switching position by an operation unit (not illustrated) such as a 4WD-2WD switching operation unit or input of a switching position due to slip detection of a drive wheel, input of selection of a power source, that is, an internal combustion engine 73 or a motor 74, according to an output request input to a vehicle VC, an output request when the motor 74 is selected as a power source, and a switching request input of a gear stage according to a vehicle speed.

The control unit 50 acquires an angle command value according to the input of the switching position (S110). The angle command value according to the input of the switching position is acquired using, for example, a table of the switching position and the angle command value prepared in advance. The position switching table illustrated in FIG. 9 is used as the table, for example. The control unit 50 outputs the angle command value signal to the electric motor 51 (S120), and ends this processing routine. In a case where the control unit 50 is a vehicle overall control unit, the angle command value signal is a signal instructing an angle to a control unit of an electric motor. In a case where the control unit 50 is a control unit of an electric motor, the angle command value signal is a drive signal for the electric motor 51, such as a rectangular drive current signal or a rectangular drive voltage signal.

### Other Embodiments

(1) The arrangement pattern or the shape of the groove included in each of the position switching groove groups G1, G2, G3, G4, G5, G6 in each of the above embodiments is merely an example. The bypass 26 and the communication path 27 are arranged such that the switching position can be sequentially and continuously switched, and the switching position can also be directly switched to a target switching position while maintaining the current switching position regardless of the order, that is, without passing through the intermediate switching position. The first movement restriction part 28 can be appropriately changed as long as it is provided. Each of the above embodiments, such as the second or third embodiment merely illustrates an example of direct switching that does not depend on the order from the current switching position to the target switching position, and it is possible to further achieve many kinds of direct switching that does not depend on the order from the current switching position to the target switching position according to the application.

(2) The number of position switching groove groups G1, G2, G3, G4, G5, G6 in each of the above embodiments is merely an example, and three or more position switching groove groups may be provided. In this case, three or more position switching devices may be used in accordance with the number of position switching groove groups. The number of grooves included in each position switching groove group may be four or more. Each groove may be formed over the entire circumference of the surface 11 of the rotating body 10 or may be formed in a part thereof. In a case where the groove is formed on a part of the surface 11 of the rotating body 10, desired position switching can be achieved by arbitrarily controlling the rotation of the rotating body 10 in the first rotation direction Dr1 and the second rotation direction Dr2 and appropriately arranging the communication path 27.

(3) While one position switching device 100 has been described in each of the above embodiments, a plurality of position switching devices 100 may be used to perform more complicated position switching control.

Although the present disclosure has been described above as the embodiments and modifications, the above-described embodiments of the present disclosure are for facilitating understanding of the present disclosure and do not limit the present disclosure. The present disclosure may be modified or improved without departing from its spirit and claims, and the present disclosure includes its equivalents. For example, the technical features in each embodiment corresponding to the technical features in the form described in the summary may be used to solve some or all of the above-described problems, or to provide one of the above-described effects. In order to achieve a part or all, replacement or combination can be appropriately performed. In addition, as long as a technical feature is not described as essential in the present specification, the technical feature may be deleted as appropriate.

What is claimed is:

1. A position switching device comprising:
a rotating body that has, on a surface, a plurality of position switching groove groups each defining a plurality of switching positions and rotates about one shaft as a rotation axis;
a switching configuration provided in at least one position switching groove group of the plurality of position switching groove groups, and that causes a combination of the plurality of switching positions switched in an order determined according to a rotation to directly switch to a target combination not dependent on the order;
a driver that rotationally drives the rotating body in a first rotation direction or a second rotation direction opposite to the first rotation direction; and
a plurality of position switching rods each having one end engaged with corresponding one of the plurality of the position switching groove groups and another end engaged with corresponding one of a plurality of position switching mechanisms.

2. The position switching device according to claim 1, wherein
the switching configuration directly switches a plurality of current switching positions defining a current combination to a plurality of target switching positions defining the target combination while maintaining the plurality of current switching positions.

3. The position switching device according to claim 2, wherein
the switching configuration switches the plurality of current switching positions to the plurality of target switching positions without passing through an intermediate switching position different from the plurality of current switching positions among a plurality of intermediate switching positions defining an intermediate combination that is a combination between the current combination and the target combination in the order.

4. The position switching device according to claim 2, wherein:
the at least one position switching groove group has a plurality of grooves defining the plurality of switching positions,
the switching configuration includes
a communication path that connects a current groove and a target groove, the current groove being different, among a plurality of current grooves defining the current combination, from a plurality of target grooves defining the target combination,
a bypass that bypasses an intermediate groove different from the plurality of current grooves, among a plurality of intermediate grooves defining an intermediate combination that is a combination between the current combination and the target combination in the order, and
a first movement restriction part disposed in the current groove corresponding to a position where the communication path is connected,
the first movement restriction part, in the first rotation direction, does not allow movement of the position switching rod in the current groove and allows movement of the position switching rod from the current groove to the communication path, and
the first movement restriction part allows movement of the position switching rod in the current groove in the second rotation direction.

5. The position switching device according to claim 4, wherein
the communication path connects a current groove having the bypass among the plurality of current grooves and a target groove different from the current groove having the bypass among the plurality of target grooves, or
the communication path connects a current groove not having the bypass among the plurality of current grooves and a target groove different from the current groove not having the bypass among the plurality of target grooves.

6. The position switching device according to claim 5, wherein
the communication path includes a second movement restriction part,
the second movement restriction part allows movement of the position switching rod from one to another between adjacent grooves of the plurality of grooves in the first rotation direction, and
the second movement restriction part does not allow movement of the position switching rod between the adjacent grooves in the second rotation direction.

7. The position switching device according to claim 6, wherein
each of the first and second movement restriction parts includes an inclined part that allows movement of the position switching rod and a stepped part that does not allow movement of the position switching rod.

8. The position switching device according to claim 6, wherein
the first and second movement restriction parts are first and second switching gates each of which switches a communicating state between the communication path and the groove according to a rotation direction of the rotating body.

9. The position switching device according to claim 1, wherein
the position switching rod includes a biasing mechanism that biases the one end toward the position switching groove group, the one end sliding on the position switching groove group.

10. The position switching device according to claim 1, wherein
the position switching rod includes a biasing mechanism that biases the one end, the one end separated from a bottom of a groove of the position switching groove group to move along the position switching groove group.

11. The position switching device according to claim 1, further comprising
the plurality of position switching mechanisms, wherein
the plurality of position switching mechanisms are provided corresponding to the plurality of position switching groove groups, positions of the plurality of position switching mechanisms changed according to the switching positions.

12. A rotating body that rotates about one shaft as a rotation axis used in a position switching device, the rotating body comprising:
a plurality of position switching groove groups each defining a plurality of switching positions and formed on a surface; and
a switching configuration provided in at least one position switching groove group of the plurality of position switching groove groups, and that causes a combination of the plurality of switching positions switched in an order determined according to a rotation to directly switch to a target combination not dependent on the order.
